(19) United States
(12) Patent Application Publication
(10) Pub. No.: US 2014/0033053 A1
(43) Pub. Date: Jan. 30, 2014

(54) METHOD FOR EXECUTING WIDGETS IN A PROCESSING DEVICE

(71) Applicants: Daniel Jesus Coloma Baiges, Madrid (ES); Michael Schneider, Madrid (ES)

(72) Inventors: Daniel Jesus Coloma Baiges, Madrid (ES); Michael Schneider, Madrid (ES)

(73) Assignee: TELEFONICA, S.A., Madrid (ES)

(21) Appl. No.: 13/977,798

(22) PCT Filed: Dec. 27, 2011
(86) PCT No.: PCT/EP2011/074065

§ 371 Date: Oct. 11, 2013

(30) Foreign Application Priority Data
Jan. 11, 2011 (ES) P201130023

(51) Int. Cl. G06F 3/0484

(52) U.S. Cl. CPC G06F 3/0484
USPC 715/736

(57) ABSTRACT

Comprises providing several widgets and linking them to exchange data there between for performing the execution of an application or functionality, the method further comprising providing a widget suite grouping said several widgets and having an external entry point associated to one of said several widgets.

### FIELD OF THE ART

The present invention generally relates to a method for executing widgets in a processing device, comprising providing and linking several widgets, and more particularly to a method comprising providing a widget suite grouping said several widgets.

The method of the invention provides Widget Extensions to allow Widget Suite Initialization and Intercommunication. According to the above, by means of widget it has to be understood “an end-user's conceptualization of an interactive single purpose application for displaying and/or updating local data or data on the Web, packaged in a way to allow a single download and installation on a user's machine, mobile phone, or Internet-enabled device”. According to W3C [2], a widget is defined in (http://www.w3.org/TR/2010/WD-widgets-20101005/) as follows “Widgets are full-fledged client-side applications that are authored using Web standards such as [HTML5] and packaged for distribution”

Further, by means of widget suit it has to be understood a set of widgets that are installed together in an implementation. In the application the term entry point should be understood as defined according to W3C [2] (http://www.w3.org/TR/2010/WD-html5-20100304/webappapis.html), “each code entry-point represents a block of executable code that the script exposes to other scripts and to the user agent”

Finally, in the application, by an External Entry Point it needs to be understood an Entry Point as in the previous definition, which is exposed external to the entity to which this entry point belongs, i.e. the widget suite.

### PRIOR STATE OF THE ART

W3C Web Applications Working Group has created a set of widget specifications, A widget, according to W3C terminology, is “an end-user's conceptualization of an interactive single purpose application for displaying and/or updating local data or data on the Web, packaged in a way to allow a single download and installation on a user's machine, mobile phone, or Internet-enabled device”. W3C has defined a standard format to package widgets in the “Widget Packaging and Configuration” (P&C) specification [1]. That format is basically a zip file with no compression that contains all the mark-up elements, style and scripts that determine the widget appearance and behaviour.

Additionally, the package contains a configuration document, which is xml based and which schema is defined in the specification. The schema defines what is the set of parameters that the configuration document may have, such as author, version, icon, etc.

FIG. 1 is an example of a widget configuration file compliant with that specification.

When a widget is launched or executed, the implementation checks if the configuration document contains a “content” element (e.g. <content src=“initialPage.html”/>), and if so, it renders the resource identified by its attribute (initialPage.html in the example). If the configuration document does not contain a “content” element, the implementation tries to render the default initial page that is defined as “index.html”.

W3C P&C specification also describes (in section 7.3) a mechanism for extending the schema defined for the configuration document that is used in this invention. The mechanism consists in adding an extra namespace to the widget element in the configuration document apart from the widget one (http://www.w3.org/ns/widgets).

FIG. 2 shows an example of one of said widget elements.

What is stated in the above paragraph means that, apart from the widget namespace defined by W3C, the namespace with name “example” can be used in the configuration document. Elements of the example namespace will be prefixed by “example:” whereas elements of the widget namespace do not require any prefix, as it is the default one.

A URI scheme has been defined by W3C in order to allow a widget to identify resources that are available within the widget package [2]. Through this URI scheme, it is possible for a widget to access all the content that is available in the widget package.

A widget suite may be defined as a set of widgets that are installed together in an implementation. The solutions available do not allow configuring a set of widgets as a widget suite, in which, for instance, one of them is the entry point to the rest of widgets in the suite.

Additionally, the current specification, limits the number of entry points to the widget (i.e. content element) to one, which is a limitation in case widgets can intercommunicate an hence invoke other widgets with different initialization instructions.

Although the URI scheme defined by W3C [2] might be suitable to allow one widget to identify other widget resources, this has not been standardized as it was assumed to be outside W3C scope or focus. The specification states: “The scheme defined in this specification could be used to implement inter-widget communication, but that is outside the scope of this current document.”

FIG. 3 discloses the current environment in which all the widgets are isolated, have only an entry point and are not capable of intercommunicating.

Although some inventions are already available in the widget intercommunication area, they are focused in defining a mechanism to allow widgets to exchange information, but not a mechanism that allows the creation of a widget suite that provides a full control of the user experience flow. For instance, the “Linked Widgets” [3] invention defines a mechanism to allow a widget to exchange data with other widgets, i.e. it discloses a method for executing widgets comprising providing several widgets and linking them to exchange data there between for performing the execution of at least one application or functionality. However, that invention has some issues such as:

1) The concept of widget suite is not defined. Hence the idea of a unique entry point in a widget suite is not defined either.

2) It does not consider that widgets may occupy the entire device display, and hence, widget communication may be a way to specify the device user experience.

3) It does not take into account that widgets may have different entry point, depending on the purpose of their invocation.

4) It requires a centralized element that keeps track of all the links between the widgets.

5) It does not allow a widget to express in its configuration document which entry points are exposing to other widgets.

6) It considers that widgets use a non-standard configuration document (not based in W3C specifications [1].

7) It does not define a standard and generic mechanism through which widgets can exchange information, such as URL encoding.

### DESCRIPTION OF THE INVENTION

It is necessary to offer an alternative to the state of the art which covers the gaps found therein, particularly those referring to the lacks that proposal [3] has referring to the use of linked widgets.

To that end, the present invention provides a method for executing widgets in a processing device, comprising providing several widgets and linking them to exchange data there between for performing the execution of at least one application or functionality.

On contrary to [3], the method of the invention comprises:
providing a widget suite by grouping said several widgets, each one of said several widgets having different entry points in order to cooperate with each other, and said widget suite having at least one external entry point associated to one of said several widgets;
using said different entry points of each one of said several widgets for starting its execution in different points depending on the functionality required; and
invoking, in order to execute said at least one application or functionality, at least one of said several widgets by indicating a requested targeted widget and the requested entry point or just a requested targeted functionality.

For a preferred embodiment, said external entry point is the only external entry point of said widget suite.

The method also identifies, out from said several widgets, one widget as a main widget within said widget suite, said external entry point being associated to said main widget, and executing said main widget first.

Furthermore, it also performs automatically and sequentially the following actions:
launching or executing the widget suite;
detecting that a first of said several widgets has declared that it is the main widget, or widget suite entry point;
executing said first widget, causing the rendering of first content;
detecting, during or as a result of said first widget execution, the need to invoke a second widget with a specific entry point;
requesting to load said second widget with the appropriate content for said specific entry point; and
executing said second widget, causing the rendering of second content.

Further embodiments of the invention are described according to the appended claims, and in a following section with reference to the accompanying drawings.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows an example of widget configuration document.

FIG. 2 shows an example of a widget extension, which means that apart from the widget namespace defined by W3C, the namespace with name “example” can be used in the configuration document. Elements of the example namespace are prefixed by “example:” whereas elements of the widget namespace do not require any prefix, as it is the default one.

FIG. 3 discloses the current conventional environment in which all the widgets are isolated, have only an entry point and are not capable of intercommunicating.

FIG. 4 provides an overview of the method of the invention, for an embodiment, in which a set of widgets (i.e. a Widget Suite) only has an external entry point. These widgets can intercommunicate through additional entry points that enable them to cooperate.

FIG. 5 shows an example of a widget configuration document using the extensions proposed in this invention.

FIG. 6 shows a Widgetsuite URI scheme according to an embodiment of the invention.

FIG. 7 illustrates examples of usage of the Widgetsuite URI scheme of FIG. 6.

FIG. 8 illustrates an environment in which 3 widgets compose a widget suite provided by the method of the invention, as per an embodiment.

FIG. 9 displays an example of a possible page displayed in the screen of a portable processing device, by the execution of a widget as per a specific entry point.

FIG. 10 shows the widget suite of FIG. 8, where, as per an embodiment of the method of the invention, a request done to load Widget 1 with the appropriate content for a specific entry point is illustrated in the form of arrow-line 2 going from Widget 2 to Widget 1.

FIG. 11 shows the new content rendered by Widget 1 while it is being executed, by displaying graphics in the screen of a portable processing device.

FIG. 12 shows the widget suite of FIG. 8, where, as per an embodiment of the method of the invention, Widget 2 is being invoked from Widget 1 (for instance, if the user select the “Home Button”) so that it is loaded again, said invocation being illustrated in the form of arrow-line 3 going from Widget 1 to Widget 2.

FIG. 13 shows the widget suite of FIG. 8, where, as per an embodiment of the method of the invention, Widget 1 is launched again but with a different entry point than the one used initially (and shown in FIG. 10), after the user selects a different option (e.g. “Message Inbox), said new launching being illustrated in the form of arrow-line 4 going from Widget 2 to Widget 1.

FIG. 14 shows the new interface displayed to the portable processing device screen as a result of the execution of Widget 1 using a different entry point.

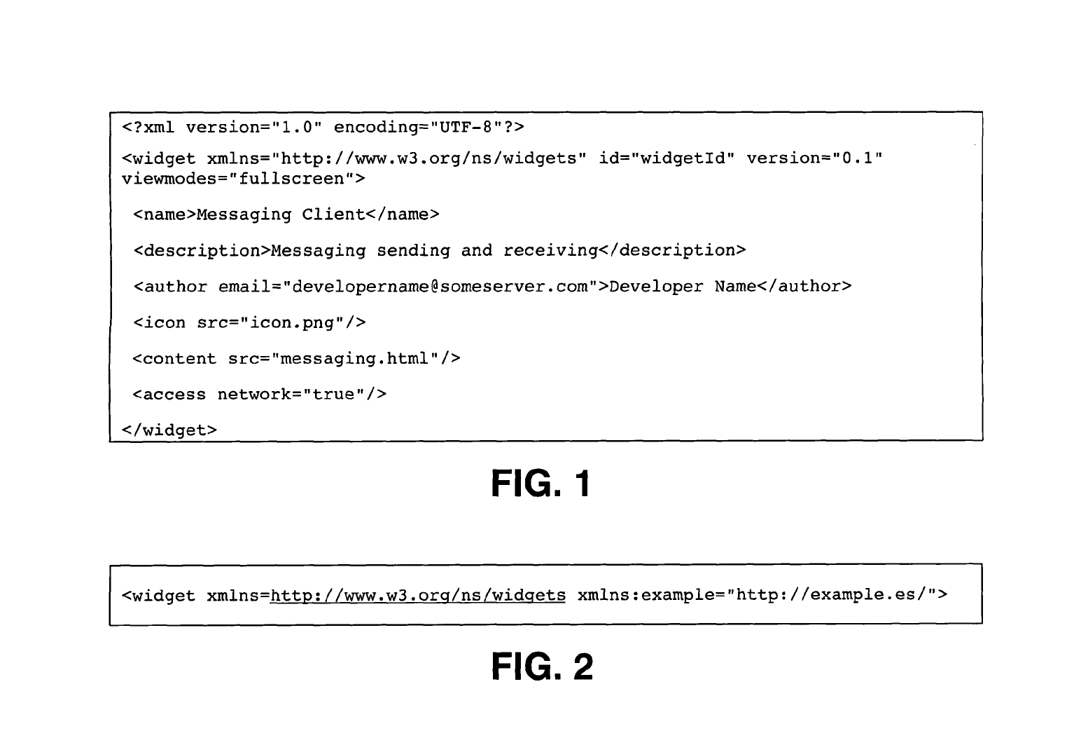

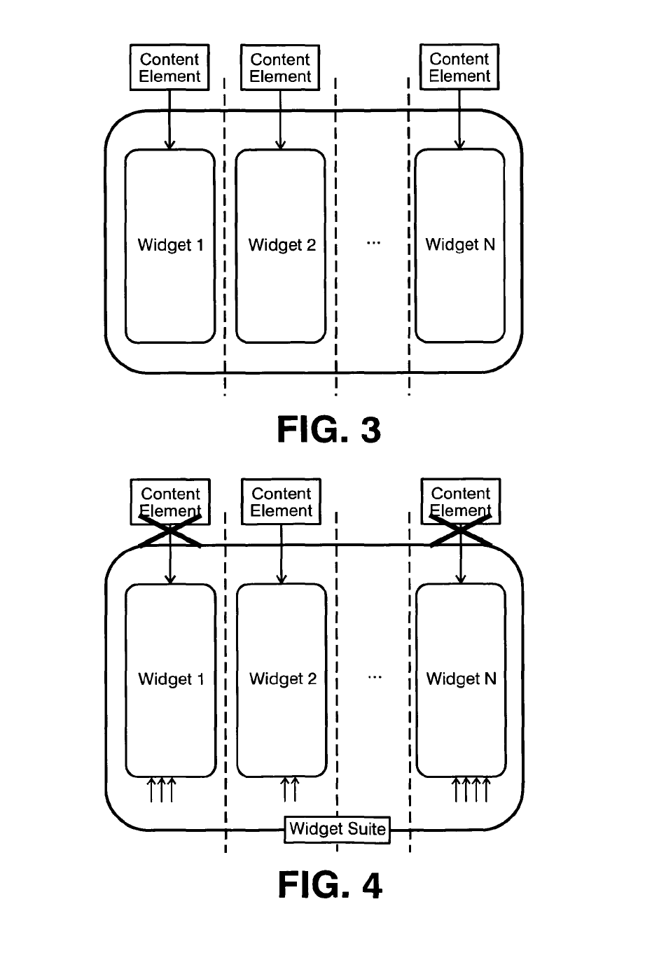

### DETAILED DESCRIPTION OF SEVERAL EMBODIMENTS

The invention proposes the definition of a set of extensions to the W3C Widget Packaging and Configuration [1] and W3C Widget URI [2] specifications to allow:
Identifying the main widget within a widget suite, so that when a widget suite is executed, the implementation knows which widget should be executed first.
Allow widgets to define multiple entry points, so that a widget can start in different points depending on the functionality is required from it.
Invoke other widgets, so that widgets in the same suite can inter-work and reuse their functionality by indicating the targeted widget and the entry point or the targeted functionality.

FIG. 4 provides an overview of the envisioned solution, in which a set of widgets (i.e. a Widget Suite) only has an external entry point. These widgets can intercommunicate through additional entry points that enable them to cooperate.

The scenario depicted by FIG. 4 may be useful in different situations:

For instance, in case a widget is originally supposed to implement a lot of functionalities, the proposed invention allows the developer to split the functionality in different widgets that can cooperate with each other. This would make code creation and maintenance considerable easier due to the possibility to create a layered solution.

The invention could be also used for creating a widget suite that provides all the functionality required in a device (a handset, a set-top-box, a desktop phone . . . ). The widget suite could comprise different widgets which are responsible for different device features (a messaging widget, a telephony widget . . . ).

Next the method of the invention is divided in two main parts, for an embodiment related to the implementation of the actions of the method as Widget extensions.

Part 1: Extensions to the Widget Configuration Document:

This part of the invention consists on a set of extensions to the format specified by W3C Widgets Packaging and Configuration specification for the widget configuration document. This is achieved through the definition of the namespace in which a set of extensions to the widget configuration document is specified, the namespace wgtsuite=http://wgtsuite.com is defined for that purpose.

The first extension to be part of that namespace is the addition of an extra attribute to the “content” element to indicate if a widget is the widget suite entry point. Currently, the content element may have only a single occurrence with just one attribute (“src”). The new attribute is suggested to be named “wgtsuite:initial”, which may take a Boolean value (“false” or “true”). If the value is “true” that means that the widget is meant to be the entry point to all the widgets in the widget suite, if “false” the widget is not an entry point for the “widget suite”.

The second extension is the definition of a new element, to allow other entry points apart from the one indicated by the content element or the default one (index.html). For that purpose, the element “wgtsuite:content” is defined. That element must always have a “src” attribute that indicates the resource to be launched when the widget is invoked with this entry point. The “wgtsuite:content” element may, in addition, include an “intent” attribute that indicates which indicates the action that widget will do when it is launched through this entry point.

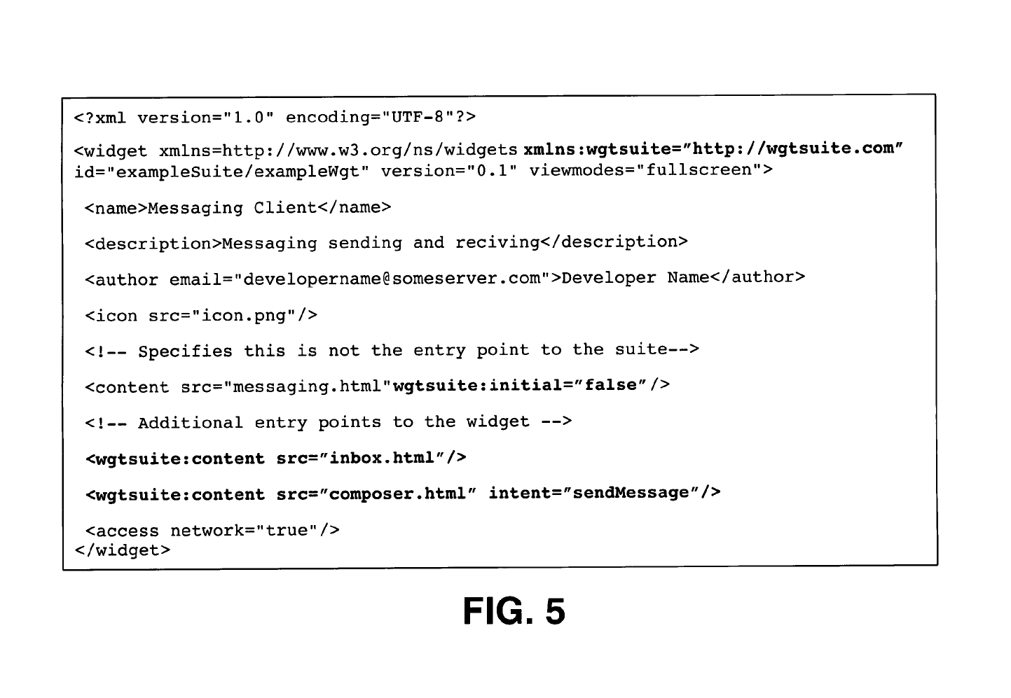

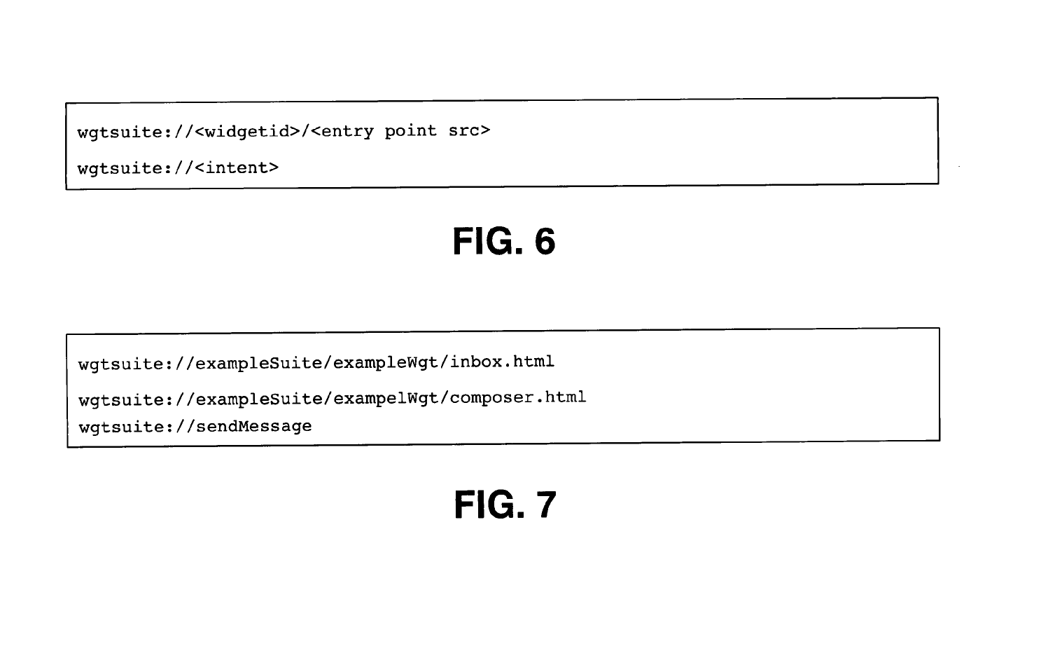

The FIG. 5 shows an example of a widget configuration document using the extensions proposed in this invention.

The widget identifiers for all the widgets within a widget suite should be the concatenation of the widget suite identifier, the “/” character and the widget identifier within the suite (<widgetSuiteId>/<widgetId>) so that the implementation can easily identify the widgets belonging to the same suite.

For instance, in the FIG. 5 example, the widget suite identifier is “exampleSuite” and the identifier of the widget within the suite is “exampleWgt”. The string “exampleSuite:exampleWgt” is the fully qualified widget identifier.

Part 2: Extensions to the Widget URI Scheme:

This part of the invention consists in the definition of the mechanism through which a widget can launch widgets part of the same widget suite, indicating explicitly a widget identifier and the src element of the desired entry point or simply indicating the desired intent without the need to specify the target widget.

The proposal is to use a new URI scheme with prefix “wgtsuite”. The URI should be composed by the widget identifier, followed by a slash character “/” and the desired entry point identified by the “src” attribute of the targeted “wgtsuite:content” element. Alternatively the URI could consist just on the intent the widget is interested in launching. Parameters can be passed to the targeted widget encoded in the URL.

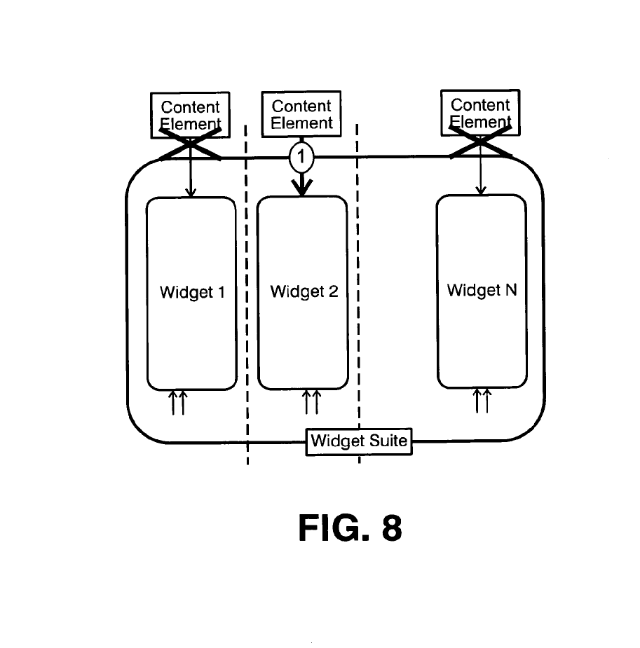

Next an embodiment of the method of the invention is described with reference to FIGS. 8 to 14, including different data flows between the widgets of the widget suite, and graphics displayed in the portable processing device D.

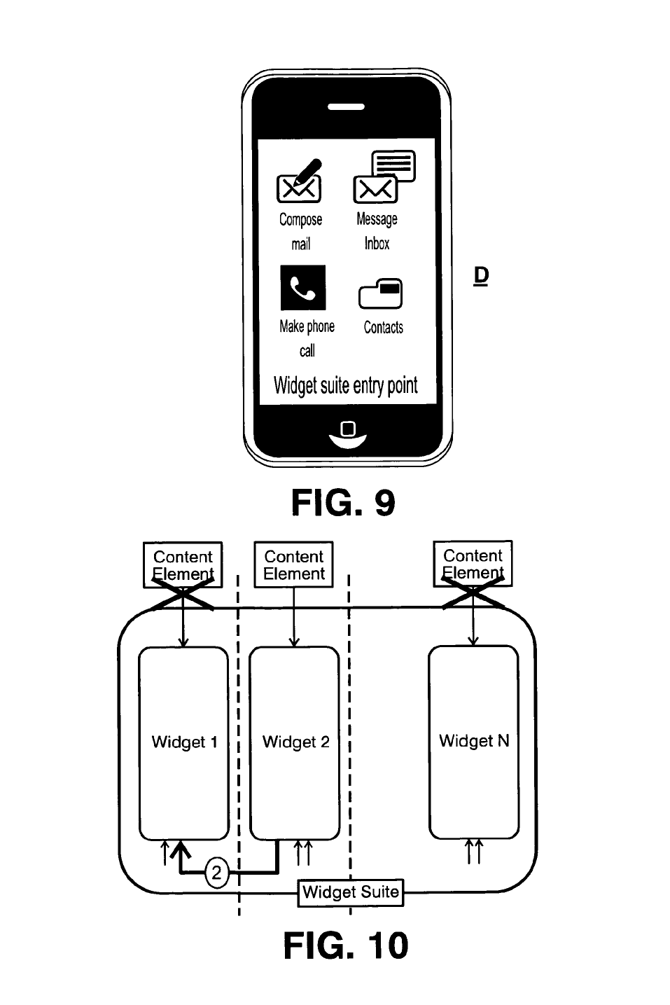

FIG. 8 discloses an environment in which three widgets compose a widget suite. When the widget suite is launched, the implementation detects that the Widget 2 has declared that it is the suite entry point (i.e. the wgtsuite:initial attribute is set to true) and automatically launches Widget 2 that displays the html resource identified in the content attribute. FIG. 9 displays an example of a possible page displayed by the entry point widget.

During the execution of Widget 2, due to the widget logic or to user interaction (e.g. clicks on a user interface button such as the “compose message” icon), the Widget 2 detects the need to invoke Widget 1 with a specific entry point (for composing the message in the example). A request is done to load Widget 1 with the appropriate content for that entry point, (FIG. 10).

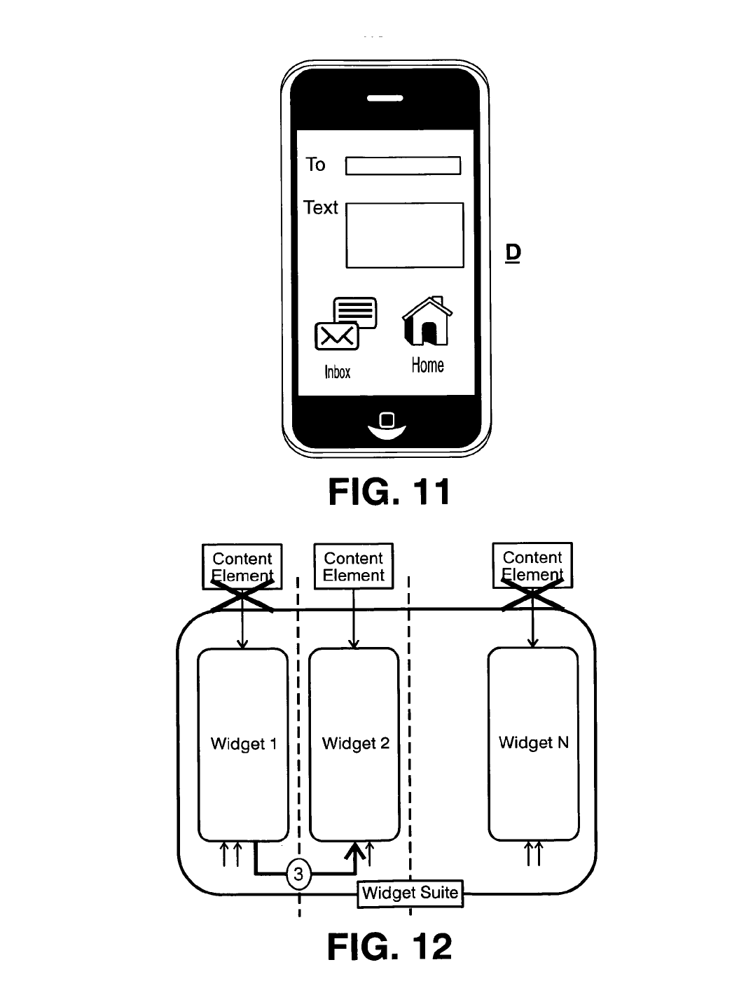

When Widget 1 is being executed it renders new content (for instance, see FIG. 11).

From Widget 1, it is also possible to invoke other widgets such as Widget 2, (for instance, if the user select the “Home Button”) so that it is loaded again (FIG. 12).

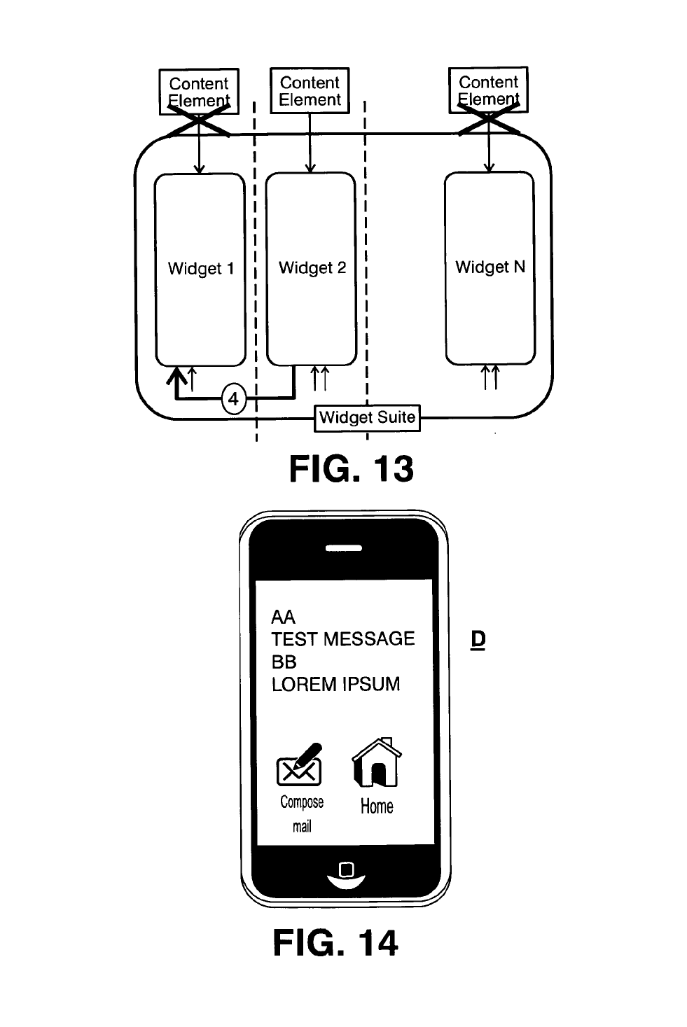

If the users selects a different option now (e.g. “Message Inbox), Widget 1 will be launched but with a different entry point than the one used initially (FIG. 13).

As a result of using a different entry point, a new interface (FIG. 14) is displayed to the end-user.

### Advantages of the Invention

This invention provides the following features:

1. It Allows widgets to communicate between them, so that they can re-use other widgets functionality in an easy manner avoiding the need of duplication of functionality.

2. It also allows a widget to implement different functionalities and expose them in a specific manner through devoted entry points, so that other widgets can directly access a customized entry point. In that way, the flexibility for widget cooperation is also increased.

3. Last but not least, the definition of an “intent” mechanism allows widgets to communicate without the need of identifying the target widget but just the desired functionality (e.g. compose a message).

A person skilled in the art could introduce changes and modifications in the embodiments described without departing from the scope of the invention as it is defined in the attached claims.

### ACRONYMS AND ABBREVIATIONS

P&C Package and Configuration

URI Uniform Resource Identifier

W3C World Wide Web Consortium

### REFERENCES

[1] W3C Widget Packaging and Configuration. http://dev.w3.org/2006/waf/widgets/.

[2] W3C Widget URI Scheme. http://www.w3.org/TR/widgets-uri/.

[3] “Linked Widgets”, United States Patent Application Publication (Forstall et al.) US 2007/0101291.

1-11. (canceled)

12. A method for executing widgets in a processing device, comprising providing several widgets and linking them to exchange data there between for performing the execution of at least one application or functionality, comprising:
providing a widget suite that provides a full control of the user experience flow of a device grouping said several widgets that are responsible for different device features, each one of said several widgets having different entry points in order to cooperate with each other, and said widget suite having at least one external entry point associated to one of said several widgets;
identifying, out from said several widgets, one widget as a main widget within said widget suite, said at least one external entry point being associated to said main widget, and executing said main widget first;
using said different entry points of each one of said several widgets for starting its execution in different points depending on the functionality required; and
invoking, in order to execute said at least one application or functionality, at least one of said several widgets by indicating a requested targeted widget and a requested entry point or just a requested targeted functionality.

13. The method of claim 12, wherein said external entry point is the only external entry point of said widget suite.

14. The method of claim 12, wherein said widget suite provides all the functionality required in a device.

15. The method of claim 12, comprising splitting an application or functionality into several tasks to be executed by said several widgets in a distributed manner.

16. The method of claim 15, wherein said tasks relate to different features of a device or to parts of a common feature of a device.

17. The method of claim 12, comprising performing automatically and sequentially the following actions:
launching or executing the widget suite;
detecting that a first of said several widgets has declared that it is the main widget, or widget suite entry point (1);
executing said first widget, causing the rendering of first content;
detecting, during or as a result of said first widget execution, the need to invoke a second widget with a specific entry point (2);
requesting to load said second widget with the appropriate content for said specific entry point; and
executing said second widget, causing the rendering of second content.

18. The method of claim 17, wherein said renderings of first and second contents relates to the displaying, in a screen of said processing device, of graphics associated to resources identified in a content attribute of said first widget.

19. The method of claim 17, comprising detecting, during or as a result of said second widget execution, the need to invoke said first widget with the same or a different entry point, and loading and executing the first widget.

20. The method of claim 17, comprising detecting, during or as a result of said second widget execution, the need to invoke a third widget with a specific entry point, and loading and executing said third widget.

21. The method of claim 19, wherein said detection of the need to invoke said second widget, said first widget or said third widget with specific entry points, is due to the previously executed widget logic or to user interaction on said processing device.

22. The method of claim 12, wherein said processing device is a portable processing device (D).
